(19) United States
(12) Patent Application Publication
(10) Pub. No.: US 2006/0259216 A1
(43) Pub. Date: Nov. 16, 2006

(54) System and method for calibrating on-board aviation equipment

(75) Inventors: Timothy L. Roberts, Litchfield Park, AZ (US); Ken L. Snodgrass, Peoria, AZ (US); Edward M. Borger, Fountain Hills, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/239,985

(22) Filed: Sep. 30, 2005

Related U.S. Application Data
(60) Provisional application No. 60/615,355, filed on Sep. 30, 2004.

(51) Int. Cl. G01M 17/00

(52) U.S. Cl. 701/29; 701/8

(57) ABSTRACT

A method is provided for testing the accuracy of on-board aviation equipment. The method includes calculating a first altitude of an in-flight aircraft from a plurality of measurements taken from a plurality of on-board measurement devices located on and permanently integrated into the aircraft. A second altitude of the aircraft is then calculated from a second plurality of measurements taken from a plurality of remote measurement devices located remotely from the aircraft. A difference between the first altitude and the second altitude is then calculated.

### CROSS-REFERENCES TO RELATED APPLICATIONS

This application claims the benefit of U.S. Provisional Application No. 60/615,355, filed Sep. 30, 2004.

### TECHNICAL FIELD

The present invention generally relates to an aviation system, and more particularly relates to a method and system for testing aviation equipment.

### BACKGROUND

Reduced Vertical Separation Minima (RVSM) is an International Civil Aviation Organization (ICAO) approved concept that permits the 1,000-foot vertical separation standard that was once applied to Flight Levels (FLs) below FL 290 (29,000 ft.) to also be applied between FL 290 and FL 410 (41,000 ft.). Previously, the minimum vertical separation allowed above FL 290 was 2,000 feet. RVSM has been implemented successfully in many different (global) regions, and Domestic RVSM (DRVSM) was implemented in the United States on Jan. 20, 2005.

The purpose of RVSM is to allow more aircraft to fly within the same airspace to reduce congestion. As shown in FIG. 1, the reduction of vertical separation from 2,000 feet to 1,000 feet between FL 290 and FL 410 creates six additional altitudes in which aircraft can operate, which increases air traffic control flexibility.

The additional flight levels shown in FIG. 1 may only be used by RVSM-certified aircraft. RVSM certification is obtained by testing the vertical error in on-board aviation equipment (e.g., an altimeter). Error, or inaccuracy, in the altitude reading may be caused by slight structural deformations on the surface of the aircraft, which affect the readings of the sensors used to calculate altitude, as well as wear and tear on those sensors. In order to pass the certification process, the aircraft's altimetry equipment must read within very tight requirements, based on the aircraft's production date, established by governing authorities, such as the Federal Aviation Administration (FAA). Once an aircraft has been RVSM-certified, it must be re-tested every two years.

Currently, RVSM compliance tests or certification is performed by an independent company by, for example, temporarily installing special equipment in the aircraft to collect data, taking the aircraft on a special test flight, and processing the data after the test flight to check the vertical error in the aircraft's equipment. Such an RVSM certification process can be expensive due, for example, to the fees charged by the independent company, as well as the additional fuel and personnel that may be associated with the test flight.

Accordingly, it is desirable to provide a method and system for testing the accuracy of on-board aviation equipment that does not involve the extra costs associated with having an independent company perform the compliance test or certification.

### BRIEF SUMMARY OF THE INVENTION

A method is provided for testing the accuracy of on-board aviation equipment. The method comprises calculating a first altitude of an in-flight aircraft from a plurality of measurements taken from a plurality of on-board measurement devices located on and permanently integrated into the aircraft, calculating a second altitude of the aircraft from a second plurality of measurements taken from a plurality of remote measurement devices located remotely from the aircraft, and calculating a difference between the first altitude and the second altitude.

### BRIEF DESCRIPTION OF THE DRAWINGS

The present invention will hereinafter be described in conjunction with the following drawing figures, wherein like numerals denote like elements, and

FIG. 1 is a chart comparing Reduced Vertical Separation Minima (RVSM) airspace to non-RVSM airspace;

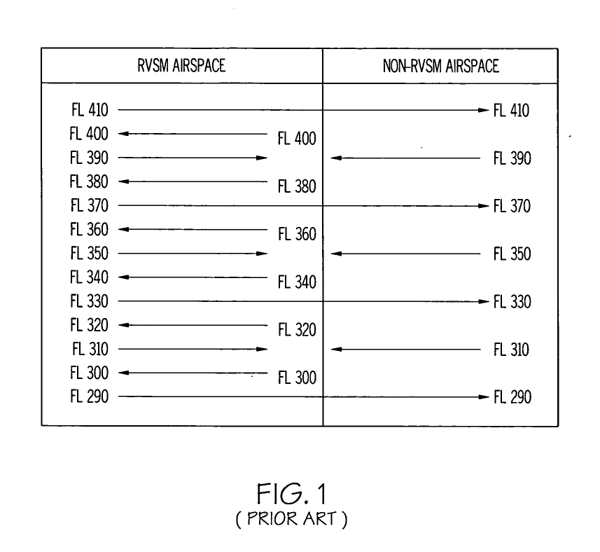

FIG. 2 is a block diagram schematically illustrating an aviation system including an aircraft and a remote computing system;

FIG. 3 is a block diagram of a navigational and control system on the aircraft illustrated in FIG. 2;

FIG. 4 is a block diagram schematically illustrating an aviation system according to another embodiment of the present invention; and

FIG. 5 is a block diagram schematically illustrating an aviation system according to a further embodiment of the present invention.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

An embodiment of the present invention provides a system and method for monitoring, testing, and validating on-board aviation equipment, such as an altimeter or similar component or system, such as an Air Data System (ADS), which indicates the aircraft altitude to a user, or pilot, of the aircraft, and overall aircraft altitude performance (“height-keeping”) and an overall quality check on the engineering work, aircraft installation, and approval process associated with the safety of, for example, RVSM operations. During what is otherwise normal operation, or flight, a computing system on the aircraft receives and stores data from numerous sensors on the aircraft. The computing system analyzes the data, calculates the altitude of the aircraft using the data, and typically indicates the calculated altitude to the pilot. A second computing system, which may include, for example, a Global Positioning System (GPS), generates data representative of the position and altitude of the aircraft without using the sensors on the aircraft. The altitude of the aircraft is then computed using the data generated by the second computing system. A comparison of the two calculated altitudes is used to indicate the accuracy of the computing system and sensors on the aircraft.

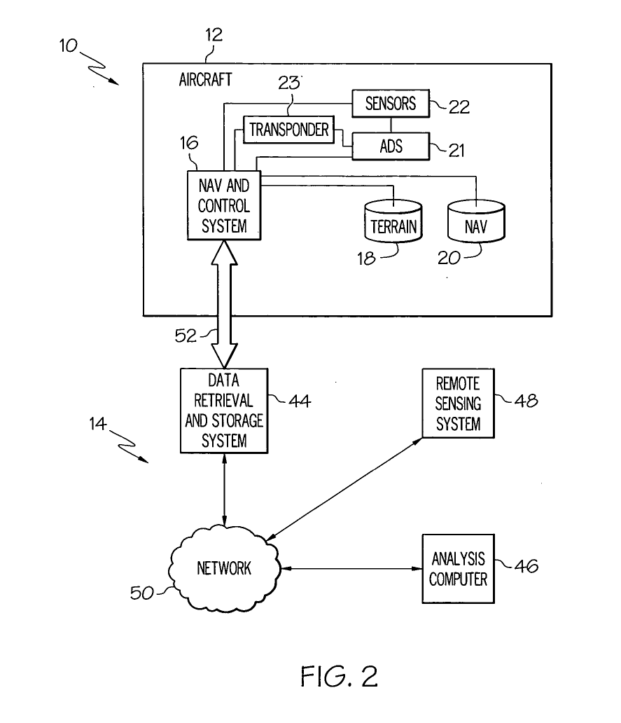

FIG. 2 schematically illustrates a system for testing the accuracy of aviation equipment, or an aviation system 10, according to one embodiment of the present invention. The aviation system 10 includes an aircraft 12 and a remote computing system 14. The aircraft 12 may be any one of a number of different types of aircraft such as, for example, a private propeller or jet engine driven airplane, a commercial jet liner, or a helicopter. As illustrated in FIG. 2, the aircraft 12 includes an on-board navigation and control system 16, a terrain database 18, a navigational database 20, an ADS 21, multiple sensors 22, and a transponder 23. In the depicted embodiment, the terrain 18 and navigational 20 databases are in operable communication with the navigation and control system 16. The sensors 22 are also in operable communication with the navigation and control system 16 and include at least a barometric pressure sensor, a thermometer, and a wind speed sensor. The ADS 21 includes, for example, a pitostatic tube system, and is in operable communication with the sensors 22 and the transponder 23, which is also in operable communication with the on-board navigation and control system 16. The transponder 23 may be an Air Traffic Control (ATC) transponder, as is commonly understood in the art.

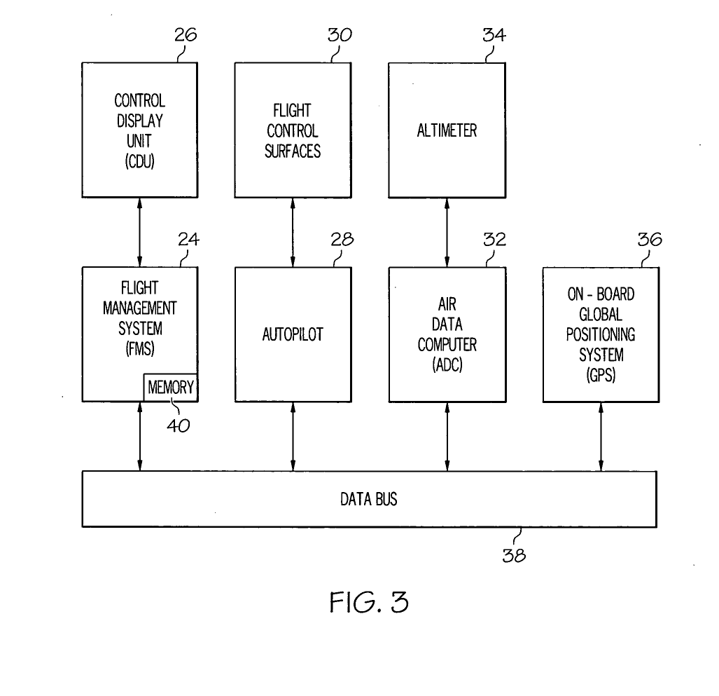

FIG. 3 illustrates an embodiment of the navigation and control system 16 in greater detail. The navigation and control system 16 includes a flight management system (FMS) 24, a control display unit (CDU) 26, an autopilot or automated guidance system 28, multiple flight control surfaces 30 (e.g., ailerons, elevators, and a rudder), an Air Data Computer (ADC) 32, an altimeter 34, and an on-board Global Positioning System (GPS) 36. In the depicted embodiment, the navigation and control system 16 additionally includes a data bus 38, which operably couples the other components of the navigation and control system 16. The FMS 24 also includes a memory 40 for electrically storing various data supplied from the other navigation and control system components.

As will be appreciated by one skilled in the art, the equipment on-board the aircraft 12 is permanently integrated into the aircraft 12 and includes aviation equipment commonly found on aircraft during normal flights.

Referring again to FIG. 2, the remote computing system 14 includes a data retrieval and storage system 44, an analysis computer 46, and a remote sensing system 48 all in operable communication via a network 50. Although not illustrated in detail, the remote sensing system 48 may include a GPS system, which is part of the global GPS system, as is commonly understood in the art, and may be in communication with multiple GPS satellites in orbit around the Earth. The network 50 may be, for example, a local area network (LAN) or a wide area network (WAN), which may be connected to the “Internet,” as is commonly understood in the art.

In use, referring to FIGS. 2 and 3, the aircraft 12 is flown in a normal operating manner. During flight, a user, or pilot, can control the aircraft 12 using the various components of the navigation and control system 16. For example, the pilot can input flight plan data to the FMS 24 using the CDU 26. The sensors 22 send various measurements and data, such as barometric pressure, temperature, and wind speed, to the FMS 24 and ADC 32. The ADC 32, along with the ADS 21, calculates the aircraft altitude for display on the altimeter 34. These and various other data may also be stored in the memory 40 of the FMS 24.

As previously mentioned, various imperfections on the surfaces and in the structure of the aircraft 12, as well as normal wear and tear on the sensors 22 and sensor performance degradation, may cause the altitude calculated by the ADC 32, known as “geometric height,” to not match or reflect the actual altitude of the aircraft 12. Therefore, the pilot may be flying the aircraft 12 at an altitude different from what he or she desires, and as a result the aircraft 12 may not be in the appropriate RVSM airspace.

Data generated by the remote sensing system 48, the FMS 24, the sensors 22, the ADS 21, as well as the information stored on the FMS 24 on the aircraft 12, may be time-indexed, or time-stamped, for post-flight analysis.

After the aircraft 12 lands, the navigation and control system 16 of the aircraft 12 may be placed operable communication with the data retrieval and storage system 44 of the remote computing system 16 via, for example, a hard-wire connection 52, or a wireless connection. Although not specifically illustrated, the hard-wire connection 52 shown in FIG. 2 may be accomplished by bringing the data retrieval and storage system 44 near the aircraft 12 and connecting the data retrieval and storage system 44 to the navigation and control system 16 through one or more network cables. The hard-wire connection 52 may alternatively be accomplished by removing a particular component from the aircraft 12, such as the FMS 24, or the memory 40 within the FMS 24, and later interfacing the component with the data retrieval computer 44.

The various information stored in the memory 40 of the FMS 24, including information from the transponder 23, is transmitted to the data retrieval and storage system 44. The transmitted information may include, for example, the various barometric pressures, temperatures, wind speeds supplied from the sensors 22 and the altitudes calculated by the ADC 32. The information is then sent from the data retrieval and storage system 44 to the analysis computer 46 via the network 50. It will be appreciated that the various altitudes for the aircraft 12 that were calculated by the remote sensing system 48 are also sent to the analysis computer 46 via the network 50.

The analysis computer 46 compares the information transferred from the navigation and control system 16 on the aircraft 12 to the altitudes calculated by the remote sensing system 48. If the altitudes calculated by the ADC 32, or ADS 21, on the aircraft 12 differ from the altitudes calculated by the remote sensing system 38 by more than a predetermined amount which may be a height-keeping requirement as mandated by regulatory authorities, such as, for example, 65 feet, an alarm or other sort of indication is supplied to the user of the remote computing system 16 or analysis computer 46. If, however, the altitudes do not differ by more than the predetermined amount, the aircraft 12 is considered RVSM compliant.

One advantage of the method and system described above is that the accuracy of the altitude-measuring devices on the aircraft may be tested using the equipment that is already permanently integrated into the aircraft. Therefore, in order to have the aircraft RVSM certified or tested for compliance, extra equipment does not need to be brought onto the aircraft, and there is no need to hire an independent company to perform the RVSM compliance check. Additionally, the process may take place during a regularly scheduled flight. Therefore, the costs involved with operating the aircraft are decreased because extra fuel does not need to be purchased, and a pilot does not need to be hired, for an extra flight.

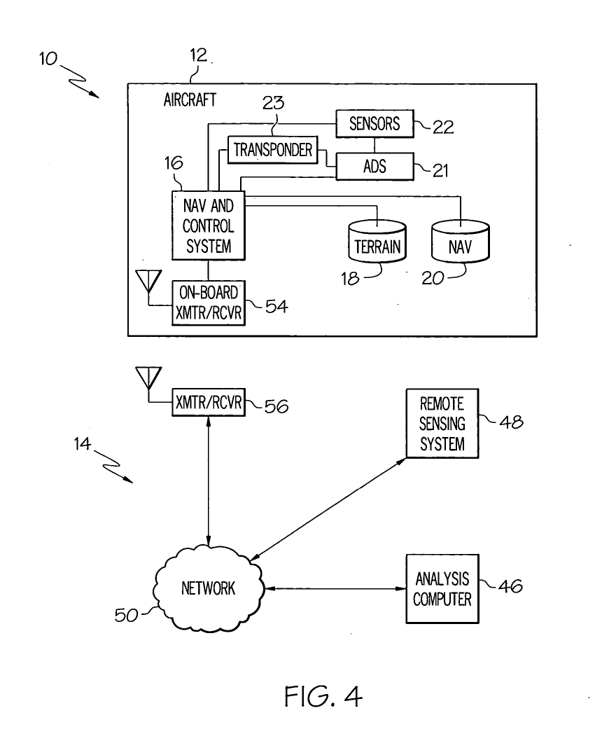

FIG. 4 illustrates the aviation system 10 according to another embodiment of the present invention. As illustrated, the aviation system 10 may include many of the same components as the aviation system illustrated in FIG. 2. However, the aviation system 10 illustrated in FIG. 4 additionally includes an on-board transceiver 54 in operable communication with the navigation and control system 16 and a transceiver 56 in the remote computing system in place of the data retrieval and storage system 44 illustrated in FIG. 2.

In use, during the flight, the ADC 32 may calculate the altitude of the aircraft 12 using measurements taken by the sensors 22 in a manner similar to that of the aviation system 10 illustrated in FIG. 2. The calculated altitudes, as well as the various measurements from the sensors 22, are stored in the memory 40 within the FMS 24. Referring specifically to FIG. 4, while the aircraft is still in flight, the on-board transceiver 54 transmits the information stored in the memory 40 of the FMS 24 and/or the calculated altitude from the ADC 32, as well as the stored measurements from the sensors 22, along with information from the transponder 23. The information is received by the transceiver 56 in the remote computing system 16, which transmits the information to the analysis computer 46 via the network 50. As described above, other information about the location and altitude of the aircraft 12 is sent from the remote sensing system 48 to the analysis computer 46 through the network 50. The analysis computer 46 calculates and compares the altitudes from the aircraft 12 and the remote sensing system 48 in a manner similar to that described above.

A further advantage of the system 10 illustrated in FIG. 4 is that the accuracy of the equipment on the aircraft 12 may be tested while the aircraft 12 is still in flight. Therefore, if the altitude calculated by the ADC 32 differs from the altitude calculated by the remote sensing system 48 by more than the predetermined amount, the pilot of the aircraft 12 may be alerted immediately.

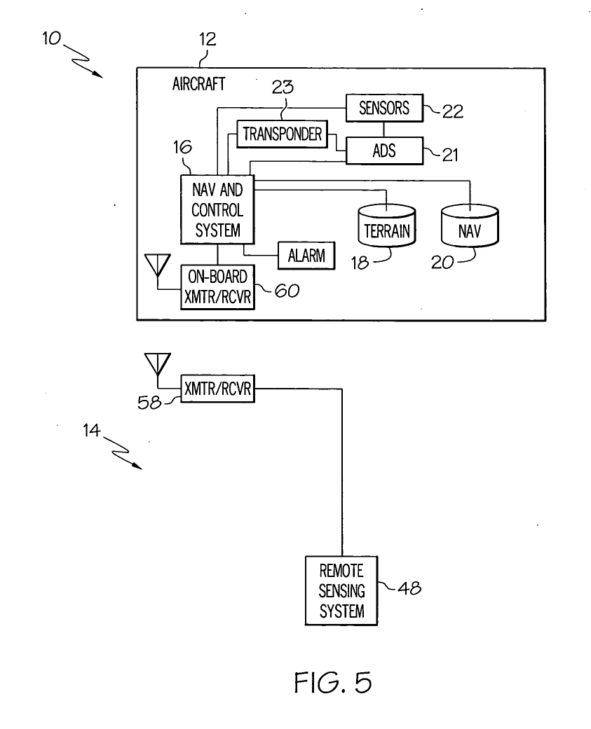

FIG. 5 illustrates the aviation system 10 according to a further embodiment of the present invention. The aviation system 10 illustrated in FIG. 5 is similar to that illustrated in FIG. 4, however, the remote computer system 16 includes a transceiver 58 connected directly to the remote sensing system 48, and the aircraft 12 includes an on-board transceiver 60 electrically connected to the navigation and control system 16. Additionally, the remote sensing system 48 shown in FIG. 5 may include a series of ground based GPS stations, in addition to a single or a constellation of GPS satellites, to calculated the altitude of the aircraft.

In use, the ADC 32 calculates the altitude of the aircraft 12 from the various measurements 22, as described above. The information is stored on the memory 40 of the FMS 24 in the navigation and control system 16. In a manner similar to that described above, the remote sensing system 48 and the remote computing system 16 collaborate with the global GPS system to calculate the actual position and the altitude of the aircraft 12. This information is sent to the transceiver 58 where it is transmitted to the on-board transceiver 60 on the aircraft 12, which may be performed while the aircraft 12 is in flight. The GPS information is sent from the on-board transceiver 60 into the navigation and control system 16 and into the FMS 24. In the example illustrated in FIG. 5, the FMS 24 within the navigation and control system 16 compares the calculations of the altitude of the aircraft from the ADC 32 to the calculations of the altitude from the GPS information from the remote sensing system 48. If the altitude calculated by the ADC 32 differs from the altitude calculated by the remote sensing system 48 by more than the predetermined amount the pilot may be alerted.

A further advantage of the system 10 illustrated in FIG. 5 is that the equipment necessary to check the accuracy of the on-board equipment is located entirely on the aircraft. Therefore, there is no need to transmit any information from the aircraft for calculation, and the pilot may at any time check the accuracy of the on-board equipment.

Although the method and system of the present invention has only been described in connection with RVSM airspace, it should be understood that the system and method described above may be used for any airspace in which aircraft may fly. Other embodiments may have the data retrieval and storage system 44 located on and permanently integrated into the aircraft 12. The various components of the navigation and control system 16 may be coupled by a compliment of independent data buses that directly connected one component, such as the ADC 34, to another component, such as the FMS 24. The remote sensing system 48 may utilize different systems than GPS, such as radar.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method for testing the accuracy of on-board aviation equipment, comprising:
calculating a first altitude of an in-flight aircraft from a first plurality of measurements taken from a plurality of on-board measurement devices located on and permanently integrated into the aircraft;
calculating a second altitude of the aircraft from a second plurality of measurements taken from a plurality of remote measurement devices located remotely from the aircraft; and
calculating a difference between the first altitude and the second altitude.

2. The method of claim 1, wherein the first plurality of measurements and the second plurality of measurements are taken at approximately the same time.

3. The method of claim 2, further comprising storing the first plurality of measurements on an on-board computing system on the aircraft.

4. The method of claim 3, further comprising:
landing the aircraft and transferring the first measurements from the storage device on the aircraft to a remote computing system located remotely from the aircraft, and wherein said calculation of the difference between the first altitude and the second altitude is performed by the remote computing system.

5. The method of claim 3, further comprising transmitting the first plurality of measurements from the on-board computing system to a remote computing system located remotely from the aircraft, and wherein said calculation of the difference between the first altitude and the second altitude is performed by the remote computing system.

6. The method of claim 3, further comprising transmitting the second plurality of measurements to the on-board computing system, and wherein said calculation of the difference between the first altitude and the second altitude is performed by the on-board computing system.

7. The method of claim 6, further comprising alerting a user on the aircraft if the difference between the first altitude and the second altitude is greater than a predetermined amount.

8. The method of claim 7, wherein the computing system on the aircraft is a Flight Management System (FMS).

9. A method for testing the accuracy of on-board aviation equipment, comprising:
recording a first data set associated with an in-flight aircraft from a first plurality of sensors on an on-board computing system, the on-board computing system and the sensors being located on and permanently integrated on the aircraft;
recording a second data set associated with the in-flight aircraft from a second plurality of sensors located remotely from the aircraft, the first and second data sets being taken at approximately the same time;
transferring the first data set and the second data set to a remote computing system located remotely from the aircraft;
calculating first and second altitudes of the aircraft from the respective first and second data sets with the remote computing system; and
calculating a difference between the first and second altitudes.

10. The method of claim 9, wherein the first data set and the second data comprise a plurality of measurements from the respective first and second pluralities of sensors that are taken at approximately the same time.

11. The method of claim 10, wherein the remote computing system is located on the ground, and further comprising landing the aircraft and electrically connecting the on-board computing system with the remote computing system before said transfer of the first data set from the on-board computing system to the remote computing system.

12. The method of claim 11, wherein the first plurality of sensors comprises a barometer and a wind speed sensor.

13. The method of claim 12, wherein at least one of the second plurality of sensors and the remote computing system comprises a Global Positioning Satellite (GPS) system.

14. The method of claim 13, wherein the on-board computing system comprises at least one of a Flight Management System (FMS) and an Air Data Computer (ADC).

15. A method for determining whether an aircraft is RVSM certified, comprising:
generating a first data set from a first plurality of sensors on and permanently integrated into an in-flight aircraft;
calculating a first altitude from the first data set with an on-board computing system, the on-board computing system being permanently on and permanently integrated into the in-flight aircraft;
generating a second data set from a second plurality of sensors located remotely from the in-flight aircraft;
storing the second data set on a remote computing system located remotely from the in-flight aircraft;
calculating a second altitude from the second data set; and
calculating a difference between the first altitude and the second altitude with the on-board computing system.

16. The method of claim 15, further comprising transmitting at least one of the second data set and the second altitude from the remote computing system to the on-board computing system on the aircraft.

17. The method of claim 16, wherein the predetermined amount is 65 feet.

18. The method of claim 17, wherein the first plurality of sensors comprises a barometric pressure sensor and a wind speed sensor.

19. The method of claim 18, wherein the at least one of the second plurality of sensors and the remote computing system comprises a Global Positioning Satellite (GPS) system.

20. The method of claim 19, wherein the on-board computing system comprises at least one of a Flight Management System (FMS) and an Air Data Computer (ADC).
